(19) United States
(12) Patent Application Publication
(10) Pub. No.: US 2015/0343417 A1
(43) Pub. Date: Dec. 3, 2015

(54) A SURFACE MODIFIED ZEOLITE FOR DRYING REFRIGERANTS

(71) Applicant: RELIANCE INDUSTRIES LIMITED, Mumbai, Maharashtra (IN)

(72) Inventors: Vijayalakshmi Ravi PURANIK, Vadodara (IN); Prakash KUMAR, Vadodara (IN); Raksh Vir JASRA, Vadodara (IN)

(73) Assignee: RELIANCE INDUSTRIES LIMITED, Mumbai, Maharashtra (IN)

(21) Appl. No.: 14/427,268

(22) PCT Filed: Sep. 4, 2013
(86) PCT No.: PCT/IN2013/000539

§ 371 Date: Mar. 10, 2015

(30) Foreign Application Priority Data
Sep. 11, 2012 (IN) 2635/MUM/2012

(51) Int. Cl. B01J 20/18; B01D 53/02; B01D 15/08; B01D 53/26; B01J 20/30; B01J 20/28

(52) U.S. Cl. CPC B01J 20/18; B01J 20/3078; B01J 20/3085; B01J 20/2803; B01J 20/28083; B01J 20/3042; B01D 15/08; B01D 53/261; B01D 53/02; B01D 2257/80; B01D 2253/108

(57) ABSTRACT

The present disclosure relates to a surface modified zeolite having formed pores therein, with apertures on the surface of the zeolite of diameter less than 4.4° A without reduction of the pore volume. The present disclosure also relates to a process for the preparation of the surface modified zeolite and a method of selectively removing substances with molecular size below 4.4 A° from fluids by using the surface modified adsorbents.

### FIELD OF THE DISCLOSURE

This disclosure relates to a modified adsorbent and a process for preparation thereof The present disclosure also relates to a process of drying refrigerants using the modified adsorbent. Further, this disclosure also relates to a dryer assembly for drying refrigerants.

### BACKGROUND

Chlorofluorocarbons, CFCs, also known as Freon™ are used as refrigerants for producing chilled water in the petrochemical industry. It is widely used as a refrigerant in refrigeration. A typical refrigeration system comprises a compressor, a condenser, a refrigerant expansion device and an evaporator. A major problem in the operation of refrigeration is purging out the condensable and non-condensable contaminants, such as moisture. Excessive moisture is introduced into the refrigeration system through leaking seals, faulty piping, higher moisture content in fresh refrigerant cylinders or lubricants or moisture on new parts installed in the system, leaks in the condenser and evaporator.

It is well documented in literature that moisture accumulating in the refrigeration system severely affects its operation by causing corrosion due to hydrolysis of chloride/fluoride group present in the CFC leading to the formation of HCl or HF, buildup of oil sludge and freezing of the refrigerant expansion device thereby causing a pressure build up in the system.

Molecular sieves have been found to have great utility in purification of refrigerant containing systems. For example, a process for drying fluoropropene is disclosed in U.S. 20100162738 that employs a molecular sieve. A zeolite based desiccant for drying a refrigerant comprising difluoromethane is disclosed in U.S. Pat. No. 6,313,059. More than about 60 percent of the available cations in the desiccant described in U.S. Pat. No. 6,313,059 are exchanged with potassium and a clay binder.

Modification of zeolitic molecular sieve adsorbent for removing smaller molecules like carbon dioxide from gaseous mixtures has been disclosed in WO2010109477. The zeolitic molecular sieve adsorbent as disclosed in WO2010109477 is used in the form of a packing column without any binder.

Other documents that disclose modified zeolitic molecular sieve for various purposes are U.S. Pat. No. 4,477,583, U.S. Pat. No. 4,477,583, U.S.20090048094, and U.S. Pat. No. 7,387,978.

For drying refrigerants, it is necessary to utilize a molecular sieve wherein the apparent size of the sieve is such that water molecules are adsorbed in the cavities of the sieve from which the refrigerant molecules are completely excluded.

There is thus felt a need for a process for drying of refrigerants that employs a modified zeolitic molecular sieve which is capable of selectively adsorbing moisture from the refrigerants.

### OBJECTS

Some of the objects of the present disclosure are described herein below:

It is an object of the present disclosure to provide an adsorbent which selectively adsorbs water/moisture.

It is still another object of the disclosure to provide an adsorbent for drying a moist chemical substance using a modified adsorbent with improved selectivity.

It is yet another object of the present disclosure to provide a process for modifying the adsorbent for imparting selective water adsorption capability through surface modification.

Other objects and advantages of the present disclosure will be more apparent from the following description when read in conjunction with the accompanying figure, which are not intended to limit the scope of the present disclosure.

### DEFINITIONS

As used in the present specification, the following words and phrases are generally intended to have the meanings as set forth below, except to the extent that the context in which they are used to indicate otherwise.

The term “moist chemical substance” is to be construed broadly and it includes reference to chemical substances either in pure form or mixtures thereof with a moisture content ranging between 0.01% to 0.03%.

The term “refrigerant” as used in the context of the disclosure is to be construed in its broadest possible sense and it includes references to refrigerants from various classes such as R-11, R-123 and R134A.

Modifier means organic silicate compounds such as Tetraethyl silicate, tetrapropylsilicate, tetrabutylsilicate

TEOS means tetra-ethyl-orthosilicate.

Throughout this specification the word “comprise”, or variations such as “comprises” or “comprising”, will be understood to imply the inclusion of a stated element, integer or step, or a group of elements, integers or steps, but not the exclusion of any other element, integer or step, or a group of elements, integers or steps.

The use of the expression “at least” or “at least one” suggests the use of one or more elements or ingredients or quantities, as the use may be in the embodiment of the invention to achieve one or more of the desired objects or results.

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used in describing a value or an end-point of a range; the disclosure should be understood to include the specific value or end-point referred to.

### SUMMARY

In accordance with one aspect of the present disclosure, there is provided a surface modified zeolite having formed pores therein with apertures on the surface of the zeolite of diameter less than 4.4° A without reduction of the pore volume.

Typically, the surface modified zeolite is adapted to adsorb molecules with a molecular size below 4.4° A from any fluid.

Typically, the surface modified zeolite is Zeolite A, preferably zeolite 4 A.

Typically, the surface of the zeolite is modified with tetra-ethyl-orthosilicate.

In accordance with another embodiment of the present disclosure, the surface modified zeolite further comprises a binder selected from a group comprising kaolin clay and a kaolin-clay-based-zeolite.

Typically, the surface modified zeolite further comprises bentonite clay as a binder. Typically, the surface modified zeolite is in a form selected from the group consisting of a pellet and a bead.

Typically, the surface modified zeolite is capable of being used as a desiccant for drying refrigerants for an extended period of time ranging between 2 years and 8 years without losing its crystallinity.

Typically, the surface modified zeolite can be regenerated by purging nitrogen and can be reused as a desiccant for at least 240 times.

In accordance with another aspect of the present disclosure, there is provided a process for preparation of a surface modified zeolite, said method comprising the following steps:
activating zeolitic material by heating at a temperature ranging between 475° C. and 575° C. to obtain an activated adsorbent material;
preparing a solution of a modifier in a solvent;
subjecting the activated adsorbent material to silation by admixing the solution of the modifier and the activated adsorbent material to obtain a silanized adsorbent material;
removing the solvent from the silanized adsorbent material; and
drying and calcining the silanized adsorbent material at a temperature ranging between 20° C. and 150° C., to obtain a surface modified adsorbent material characterized by pore size of not more than 4.4 A°.

Typically, the zeolitic material is zeolite A, preferably zeolite 4 A.

Typically, the modifier is tetraethyleorthosilicate.

Typically, the amount of modifier present in the solution of the modifier ranges between 0.1 wt % and 2 wt %.

Typically, the solvent used for preparing the solution of the modifier is selected from the group consisting of toluene, benzene, cyclohexane, acetone and xylenes.

Typically, the solvent is removed at a temperature ranging between 20° C. and 40° C. under vacuum in a rotavapor by passing Nitrogen.

Typically, a binder is added with the zeolitic material before the commencement of the method step of activation; said binder being selected from the group consisting of attapulgite, kaolinite and bentonite.

Typically, the amount of the binder added with the zeolitic material ranges between 20% to 40% with respect to the mass of the zeolitic material.

In, accordance with another aspect of the present disclosure, there is provided a method of selectively removing substances with molecular size below 4.4 A° from fluids by using the surface modified.

Typically, the refrigerant is selected from the group consisting of R11, R123 and R134a by using the modified adsorbents.

### BRIEF DESCRIPTION OF THE ACCOMPANYING DRAWING

FIG. 1 illustrates schematic diagram of drying assembly of the present disclosure; wherein 2 is an adsorbent bed, 4 is a Freon drum, 6 is a compressor, 8 is a refrigeration closed loop, 10 is an evaporator, 12 is a condenser and 14 is an expansion valve.

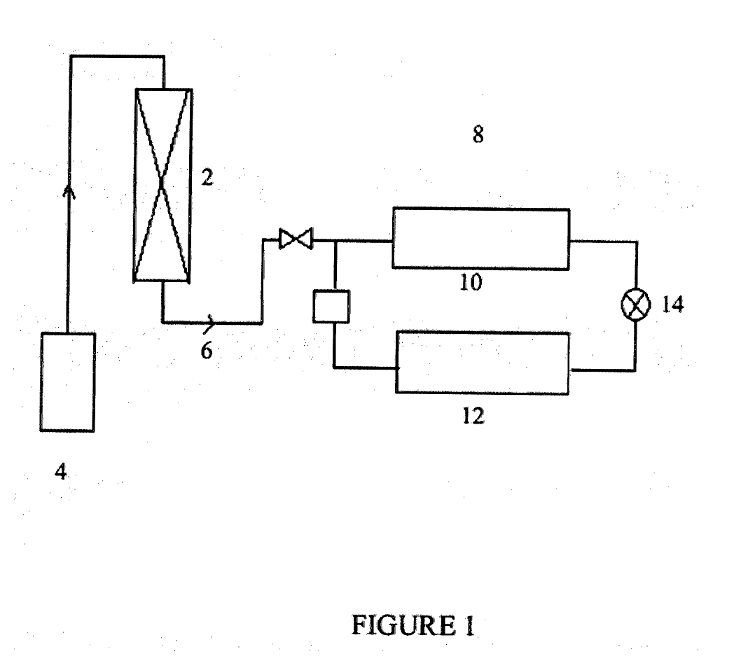

### DESCRIPTION

Molecular sieve A is especially useful in purifying refrigerant systems because of its characteristically high water capacity, particularly, at low partial pressures. Accordingly, in the first aspect of the present disclosure there is a zeolite A based molecular sieve adsorbent modified with an interfacial deposition of a modifier compound. The apertures of pores present on the surface of the modified adsorbent are specifically adapted to hinder the entry of big molecules like halo-hydrocarbons. However, they allow the entry of small molecules such as water thereby facilitating their efficient removal. The aperture size of the pores present in the modified adsorbent of the present disclosure is not more than 4.4 A°.

In accordance with an exemplary embodiment of the present disclosure the modified adsorbent is zeolite 4 A based adsorbent.

The modifier present in the modified adsorbent of the present disclosure is an alkylated orthosilicate compound with a higher kinetic diameter as compared to inorganic silica. The modifier remains present only on the external surface of the modified adsorbent and it does not enter inside the pore. As a result, the modifier merely blocks the aperture-size without reducing the pore volume. The modifier present in the modified adsorbent of the present disclosure includes TEOS.

In one of the embodiments of the present disclosure, the modified adsorbent of the present disclosure further comprises a clay binder selected from the group consisting of kaoline, kaoline derived zeolite, bentonite and attapulgite.

The modified adsorbent of the present discourse is particularly suitable for removing molecules with smaller molecular size, especially, molecules with size below 4.4 A° from any fluids comprising one or more organic compounds. The modified adsorbent hinders the entry of other substances in the fluid having larger molecular size. (that is: size greater than 4.4 A°).

In one of the embodiment of the present disclosure, the modified adsorbent in accordance with the present disclosure is used for drying moist refrigerants selected from the group consisting of R11, R123, and R134a.

The modifier on the external surface of the modified adsorbent avoids the contact of the moist chemical substance to be dried with the binder present in the adsorbent. As a result, it maintains its crystal structure for an extended period time ranging between 2 and 8 years, preferably between 4 and 7 years and still preferably between 5 and 6 years.

The modified adsorbent of the present disclosure is easily recyclable. It can be regenerated by purging nitrogen. It can be re-used at least 240 times. This feature makes it very cost-effective.

In accordance with the second aspect of the present disclosure there is provided a method for the preparation of a modified adsorbent as described herein above. It comprises the following steps:
activating a zeolite based adsorbent by heating at a temperature ranging between 300° C. and 600° C., preferably between 475° C. and 575° C. to obtain an activated adsorbent material;
preparing a solution of a modifier in a solvent;
subjecting the activated adsorbent material to silation by admixing the solution of the modifier and the activated adsorbent material to obtain a silanized adsorbent material;
removing the solvent from the silanized adsorbent material;
drying and calcining the silanized adsorbent material at a temperature ranging between 10° C. and 150° C., preferably between 20° C. and 130° C. to obtain a modified adsorbent material characterized by pores formed therein with an aperture size which is not more than 4.4 A°.

Thee solvent used for preparing the solution of the modifier is selected from the group that includes toluene, benzene, cyclohexane, acetone and xylenes. The amount of modifier present in the solution of modifier typically varies between 0.1 wt % and 2 wt %, preferably between. 0.1 wt % and 1 wt % and still preferably between 0.01 wt % and 0.02 wt %.

The solvent is typically removed at a temperature ranging between 20° C. and 150° C., preferably between 20° C. and 40° C. under vacuum in a rotavapor by passing Nitrogen.

In one embodiment, the method of preparation of the modified adsorbent further comprises a method step of incorporating a binder selected from the group consisting of kaoline, kaoline derived zeolite, bentonite and attapulgite. The binder is incorporated before the method step of activating and calcining the zeolitic material. In accordance with one of the embodiments of the present disclosure, kaoline, is used as the binder. However, it gets converted to zeolite either partially or completely during the method step of drying and calcining.

In accordance with the third aspect of the present disclosure there is provided a method for removing substances with small molecular size below 4.4 A° from fluids by employing the modified adsorbents of the present disclosure. A wide variety of fluids comprising chemical substances or mixtures thereof, can be employed such as methyl mercaptan, 1,3 butadiene, chloroform, benzene and toluene.

In accordance with one of the embodiments, the modified adsorbent of the present disclosure is used for drying refrigerants selected from the group consisting of R-11, R-123 and R134A halogenated. Typically, the method of drying the refrigerants comprises passing a stream of the refrigerant over a bed of the modified adsorbent in a drying assembly under ambient conditions of temperature and pressure.

The following non-limiting examples further illustrate the invention described in the present disclosure:

### EXAMPLES

18 kg of TEOS modified zeolite molecular sieve pellets of 1.5 mm size and bulk density of 0.65 gm/cc was charged in adsorbent bed. Freon R-123 and R-11 having moisture content of 200 ppm was passed through the adsorbent bed at a temperature of 25° C. and pressure 1.1 bar. Moisture level of Freon leaving the adsorbent bed was less than 20 ppm. Dried Freon was then circulated through closed loops of refrigeration and condenser.

### Comparative Example

25 gm of untreated 4 A zeolite molecular sieve 1.5 mm extrudates previously activated at 350° C. for 6 hours was filled in a 70 cc stainless steel cylinder under vacuum and was further charged with R-11 and R123 refrigerants followed by baking at 90 C for 140 hrs. Baked untreated zeolite molecular sieve samples were analyzed for chloride content analysis by pyrohydrolysis method. The results shows formation of higher (0.03 wt %) chloride compared to TEOS treated zeolite 4 A molecular sieve (0.01 wt %). Higher chloride content on untreated zeolite molecular sieve indicates lower degree of refrigerant compatibility compared to TEOS treated 4 A molecular sieve.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of the preferred embodiments, those skilled in the art will recognize that the embodiments herein can be practiced with modification within the spirit and scope of the embodiments as described herein.

Any discussion of documents, acts, materials, devices, articles or the like that has been included in this specification is solely for the purpose of providing a context for the invention. It is not to be taken as an admission that any or all of these matters form part of the prior art base or were common general knowledge in the field relevant to the invention as it existed anywhere before the priority date of this application.

1. A surface modified zeolite having formed pores therein with apertures on the surface of the zeolite of diameter less than 4.4° A without reduction of the pore volume.

2. A surface modified zeolite as claimed in claim 1, adapted to adsorb molecules with a molecular size below 4.4° A from any fluid.

3. A surface modified zeolite as claimed in claim 1, wherein the zeolite is Zeolite A, preferably zeolite 4 A.

4. A surface modified zeolite as claimed in claim 1, wherein the surface of the zeolite is modified with tetra-ethyl-orthosilicate.

5. A. surface modified zeolite as claimed in claim 1, further comprising a binder that comprises kaolin clay and a kaolin-clay-based-zeolite.

6. A surface modified zeolite as claimed in claim 1, further comprising bentonite clay as a binder.

7. A surface modified zeolite as claimed in claim 1, in a form selected from the group consisting of a pellet and a bead.

8. A surface modified zeolite as claimed in claim 1, that is capable of being used as a desiccant for drying refrigerants for an extended period of time ranging between 2 years and 8 years without losing its crystallinity.

9. A surface modified zeolite as claimed in claim 1, that can be regenerated by purging nitrogen and can be reused as a desiccant for at least 240 times.

10. A process for preparation of a surface modified zeolite, said method comprising the following steps:
activating zeolitic material by heating at a temperature ranging between 475° C. and 575° C. to obtain an activated adsorbent material;
preparing a solution of a modifier in a solvent;
subjecting the activated adsorbent material to silation by admixing the solution of the modifier and the activated adsorbent material to obtain a silanized adsorbent material;
removing the solvent from the silanized adsorbent material; and
drying and calcining the silanized adsorbent material at a temperature ranging between 20° C. and 150° C., to obtain a surface modified adsorbent material characterized by pore size of not more than 4.4 A°.

11. A process as claimed in claim 10, wherein the zeolitic material is zeolite A, preferably zeolite 4 A.

12. A process as claimed in claim 10, wherein the modifier is tetraethyleorthosilicate.

13. A process as claimed in claim 10, wherein the amount of modifier present in the solution of the modifier ranges between 0.1 wt % and 2 wt %.

14. A process as claimed in claim 10, wherein the solvent used for preparing the solution of the modifier is selected from the group consisting of toluene, benzene, cyclohexane, acetone and xylenes.

15. A process as claimed in claim 10, wherein the solvent is removed at a temperature ranging between 20° C. and 40° C. under vacuum in a rotavapor by passing Nitrogen.

16. A process as claimed in claim 10, wherein a binder is added with the zeolitic material before the commencement of the method step of activation; said binder being selected from the group consisting of attapulgite, kaolinite and bentonite.

17. A process as claimed in claim 16, wherein the amount of the binder added with the zeolitic material ranges between 20% to 40% with respect to the mass of the zeolitic material.

18. A method of selectively removing substances with molecular size below 4.4 A° from fluids by using a surface modified adsorbent, being surface modified zeolite having formed pores therein with apertures on the surface of the zeolite of diameter less than 4.4° A without reduction of the pore volume.

19. A method of drying a refrigerant selected from the group consisting of R11, R123 and R134a by contacting the refrigerant with a surface modified adsorbent, being surface modified zeolite having formed pores therein with apertures on the surface of the zeolite of diameter less than 4.4° A without reduction of the pore volume.
